(19) United States
(12) Patent Application Publication
(10) Pub. No.: US 2009/0119376 A1
(43) Pub. Date: May 7, 2009

(54) Hint-Based Email Address Construction

(75) Inventor: Shashidhar Bomma, Austin, TX (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSNESS MACHINES CORPORATION, ARMONK, NY (US)

(21) Appl. No.: 11/935,758

(22) Filed: Nov. 6, 2007

(51) Int. Cl. G06F 15/16

(52) U.S. Cl. 709/206

(57) ABSTRACT

Methods, apparatus, and products are disclosed for hint-based email address construction that include: receiving, in an email address constructor, an email address hint specified by a user, the email address hint representing an email address for an email recipient; parsing, by the email address constructor, the email address hint for a plurality of hint tokens, each of the hint tokens specifying a user attribute for the email recipient, and at least one of the hint tokens specifying an attribute other than the email recipient's name; and determining, by the email address constructor, the email address for the email recipient in dependence upon the plurality of hint tokens.

### BACKGROUND OF THE INVENTION

1. Field of the Invention

The field of the invention is data processing, or, more specifically, methods, apparatus, and products for hint-based email address construction.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems and networks today that are much more powerful than just a few years ago.

One of the more popular ways that people utilize these powerful computer systems and networks is for communications using electronic mail or ‘email.’ Email is an electronic message that is transferred between users in a store and forward manner over data communications systems. An email sender creates the email in an email client, which in turn transfers the email to an email server. The email is forwarded along from one email server to another until the email reaches the email server serving a recipient's email client. The recipient's email client then retrieves the email from the email server for delivery to the recipient. Transferring information in such a manner is typically cheaper and faster than sending a traditional letter, less intrusive than a phone call, and less time consuming than sending a fax. In addition, using email to communicate makes differences in location and time zone less of an obstacle to communication.

A user who exchanges information through the use of email typically has his or her own unique email address. Email addresses are of the form of ‘username@organization.xxx’ where @ is pronounced as ‘at’ and ‘organization.xxx’ refers to the domain to which the recipient's email account belongs. Examples of domains could include ‘ibm.com,’ ‘uspto.gov,’ and so on. The ‘username’ portion of the email address specifies the username within the domain associated with the recipient's email account.

When sending an email, a user typically provides either the recipient's email address or the recipient's name to the email client. When provided with the recipient's email address, the email client has the information needed to instruct the email server to deliver the email to the recipient's email address. When provided with the recipient's name, the email client may look up the recipient's email address in the sender's address book using the recipient's name provided by the sender.

One drawback to the current way of providing the recipient's email address is that often the sender does not know the recipient's email address and does not have the recipient's email address associated with the recipient's name in the sender's address book. Even in situations where the recipient's email address is associated with the recipient's name in the sender's address book, the sender may not be able to remember enough of the recipient's name to locate the entry in the address book. As such, readers will appreciate that room for improvement exists in the area of constructing email addresses for email recipients.

### SUMMARY OF THE INVENTION

Methods, apparatus, and products are disclosed for hint-based email address construction that include: receiving, in an email address constructor, an email address hint specified by a user, the email address hint representing an email address for an email recipient; parsing, by the email address constructor, the email address hint for a plurality of hint tokens, each of the hint tokens specifying a user attribute for the email recipient, and at least one of the hint tokens specifying an attribute other than the email recipient's name; and determining, by the email address constructor, the email address for the email recipient in dependence upon the plurality of hint tokens.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of hint-based email address construction according to embodiments of the present invention.

FIG. 2 sets forth a flow chart illustrating an exemplary method of hint-based email address construction according to embodiments of the present invention.

FIG. 3 sets forth a flow chart illustrating a further exemplary method of hint-based email address construction according to embodiments of the present invention.

FIG. 4 sets forth a flow chart illustrating a further exemplary method of hint-based email address construction according to embodiments of the present invention.

FIG. 5 sets forth a flow chart illustrating a further exemplary method of hint-based email address construction according to embodiments of the present invention.

### DETAILED DESCRIPTION OF EXEMPLARY EMBODIMENTS

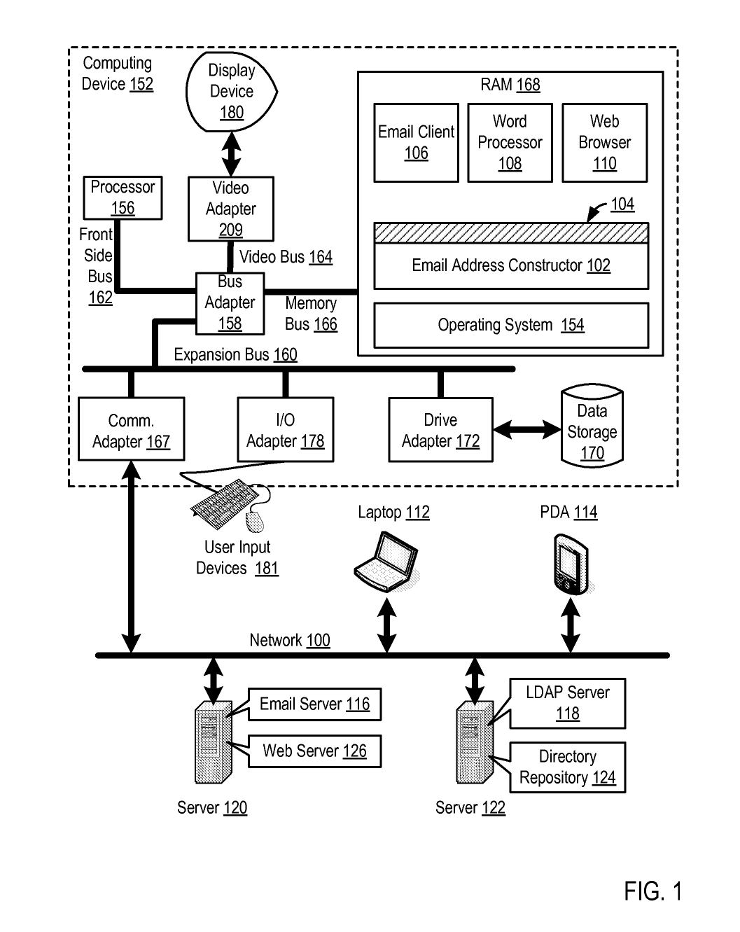

Exemplary methods, apparatus, and products for hint-based email address construction in accordance with the present invention are described with reference to the accompanying drawings, beginning with FIG. 1. FIG. 1 sets forth a functional block diagram of an exemplary system capable of hint-based email address construction according to embodiments of the present invention. The exemplary system of FIG. 1 includes several computing devices (152, 112, 114, 120, 122) connected together for data communications through a network (100).

The exemplary computing device (152) of FIG. 1 includes an email address constructor (102) stored in RAM (168). The email address constructor (102) is a software component having computer program instructions for hint-based email address construction according to embodiments of the present invention. The email address constructor (102) operates generally for hint-based email address construction according to embodiments of the present invention by: receiving an email address hint specified by a user, the email address hint representing an email address for an email recipient; parsing the email address hint for a plurality of hint tokens, each of the hint tokens specifying a user attribute for the email recipient, and at least one of the hint tokens specifying an attribute other than the email recipient's name; and determining the email address for the email recipient in dependence upon the plurality of hint tokens.

An email address hint represents an email address for an email recipient using a plurality of hint tokens. Each hint token specifies a user attribute for the email recipient such as, for example, the recipient's name, location, address, employer, organizational department, friends, family, or any other attributes as will occur to those of skill in the art. In such a manner, the user attribute specifies a characteristic describing the email recipient. At least one of the hint tokens of an email address hint, however, specify an attribute other than the email recipient's name. For example, consider the following exemplary email address hint:
Robert Austin ‘Customer Support’ IBM

The exemplary email address hint above includes four hint tokens. The first hint token specifies that the recipient's name includes ‘Robert.’ The second hint token specifies that the recipient is located in ‘Austin.’ The third hint token specifies that the recipient belongs to the organizational department identified as ‘Customer Support.’ The fourth hint token specifies that the recipient works for ‘IBM.’ Readers will note that the exemplary email address hint above is for explanation only and not for limitation. Other email address hints having other formats and other structures may also be useful in hint-based email address construction according to embodiments of the present invention.

In the example of FIG. 1, the email address constructor (102) may determine the email address for the email recipient in dependence upon the plurality of hint tokens by constructing the email address from information returned from a directory repository (124) stored on the server (122). The directory repository (124) may be implemented according to the Lightweight Directory Access Protocol (‘LDAP’) specification and accessed through the LDAP server (118) installed on server (122). LDAP is a set of protocols for accessing information directories. LDAP is based on the standards contained within the X.500 standard, but is significantly simpler. And unlike X.500, LDAP supports TCP/IP, an important feature for Internet-oriented directory access. Both LDAP and X.500 implement hierarchical directories in which particular sets of attributes of directory entries comprise distinguished names.

“X.500” is a joint standard of both the International Standards Organization (“ISO”) and the International Telecommunication Union (“ITU”) defining structure for global directories. X.500 directories are hierarchical with different levels for each category of information, such as country, state, and city. Both LDAP and X.500 implement hierarchical directories in which particular sets of attributes of directory entries comprise distinguished names. X.501 is the X.500 specification for directory models as such.

The email address constructor (102) of FIG. 1 may access the directory repository (124) using an LDAP Uniform Resource Locator (‘URL’). An LDAP URL describes an LDAP search operation that is used to retrieve information from an LDAP directory, or, in the context of an LDAP referral or reference, an LDAP URL describes a service where an LDAP operation may be progressed. Consider the following LDAP URL format described in RFC 4516 promulgated by the Internet Engineering Task Force (‘IETF’):
ldap://host:port/DN?attributes?scope?filter?extensions

In the exemplary LDAP URL format above, the ‘host’ is the DNS or IP address of the LDAP server to search. ‘Port’ refers to the network port of the LDAP server. ‘DN’ refers to the distinguished name to use as the search base. ‘Attributes’ refers to a comma-separated list of attributes to retrieve. ‘Scope’ specifies the search scope and may have values of ‘base,’ ‘one,’ or ‘sub.’ ‘Filter’ refers to a search filter such as, for example, ‘objectClass=*.’ ‘Extensions’ refer to extensions to the LDAP URL format.

When implemented according to LDAP, the directory repository (124) of FIG. 1 is usually structured hierarchically, as a tree of nodes, often referred to as the Directory Information Tree (‘DIT’). Each node represents a record, or ‘entry,’ in the directory repository (124). An LDAP entry consists of numerous attribute-value pairs, and is uniquely identified by what is known as a ‘distinguished name’ or ‘DN.’ Consider the following exemplary LDAP entry:
dn: mail=robert@ibm.com, dc=ibm, dc=com
objectclass: inetOrgPerson
cn: Robert
sn: Doe
email: robert@ibm.com
username:robert
telephoneNumber: 1 555 555 1133
department: Customer Support
location: Austin

The exemplary LDAP entry above is for a single user named ‘Robert Doe’ who works at IBM. The entry is identified by a unique DN, which is the first line of the exemplary entry above. The entry includes various attribute-value pairs, the first of which specifies the entry inherits from the ‘inetOrgPerson’ object class described in RFC 2798. Readers will note that the exemplary LDAP entry above is for explanation only. Other entries in the directory repository having other formats as will occur to those of skill in the art may be useful in hint-based email address construction according to embodiments of the present invention.

Because LDAP entries are arranged in a hierarchical tree, and because each node on the tree can be uniquely identified by a DN, the LDAP model lends itself well to sophisticated queries and powerful search filters. For example, searches may be restricted to a particular subset of the tree simply by specifying a different base for the query to begin from, or querying only against specific attributes in the directory repository.

The email address constructor (102) exposes an application programming interface (‘API’) (104) for use by other software components in order to allow these other software components to provide hint-based email address construction according to embodiments of the present invention. In the example of FIG. 1, the software components that use the email address constructor (102) include email client (106), word processor (108), and web browser (110), also stored in RAM (168). The email client (106) of FIG. 1 provides users with the ability to create and manage email as well as transfer email to and from email server (116) installed on server (120). Examples of email clients include Mozilla Thunderbird™, Microsoft Outlook®, and IBM's Lotus Notes®. The word processor (108) of FIG. 1 is a software application capable of document production, including composition, editing, and formatting. Examples of word processors include Microsoft Word and Corel's WordPerfect® The web browser (110) of FIG. 1 is a software application that enables a user to display and interact with text, images, videos, music, and other information referenced through a web page stored on web server (126) installed on server (120). Examples of web browsers include Microsoft's Internet Explorer®, Mozilla's Firefox®, and Apple's Safari®. Each of these software applications (106, 108, 110) is capable of providing the email address constructor (102) through API (104) an email address hint specified by a user to represent an email recipient's email address. In return, the software applications (106, 108, 110) receive an email address for the email recipient that may be used to send an email to the recipient or for inclusion in a document.

The explanation above with reference to FIG. 1 describes the email client (106), the word processor (108), and the web browser (110) utilizing hint-based email address construction capabilities provided by the email address constructor (102). Readers will note, however, that such a description is for explanation only and not for limitation. In some other embodiments, the email address constructor (102) may be stored on the server (120) along with the email server (116) and the web server (126). In such a manner, the email server (116) and the web server (126) may also utilize hint-based email address construction capabilities provided by the email address constructor (102) to construct email addresses as the server layer as opposed to the client layer.

Also stored in RAM (168) is an operating system (154). Operating systems useful for hint-based email address construction according to embodiments of the present invention include UNIX™, Linux™, Microsoft XP™, AIX™, IBM's i5/OS™, and others as will occur to those of skill in the art. The operating system (154), the email address constructor (102), the email client (106), the word processor (108), and the web browser (110) in the example of FIG. 1 are shown in RAM (168), but many components of such software typically are stored in non-volatile memory also, such as, for example, on a disk drive (170).

The computing device (152) of FIG. 1 includes disk drive adapter (172) coupled through expansion bus (160) and bus adapter (158) to processor (156) and other components of the computing device (152). Disk drive adapter (172) connects non-volatile data storage to the computing device (152) in the form of disk drive (170). Disk drive adapters useful in computing devices for hint-based email address construction according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory) (134), RAM drives, and so on, as will occur to those of skill in the art.

The example computing device (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computing device (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computing device (152) of FIG. 1 includes a communications adapter (167) that couples the computing device for data communications with other servers in the data center through a data communications network (100). Such a data communication network (100) may be implemented with external buses such as a Universal Serial Bus (‘USB’), or as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for hint-based email address construction according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

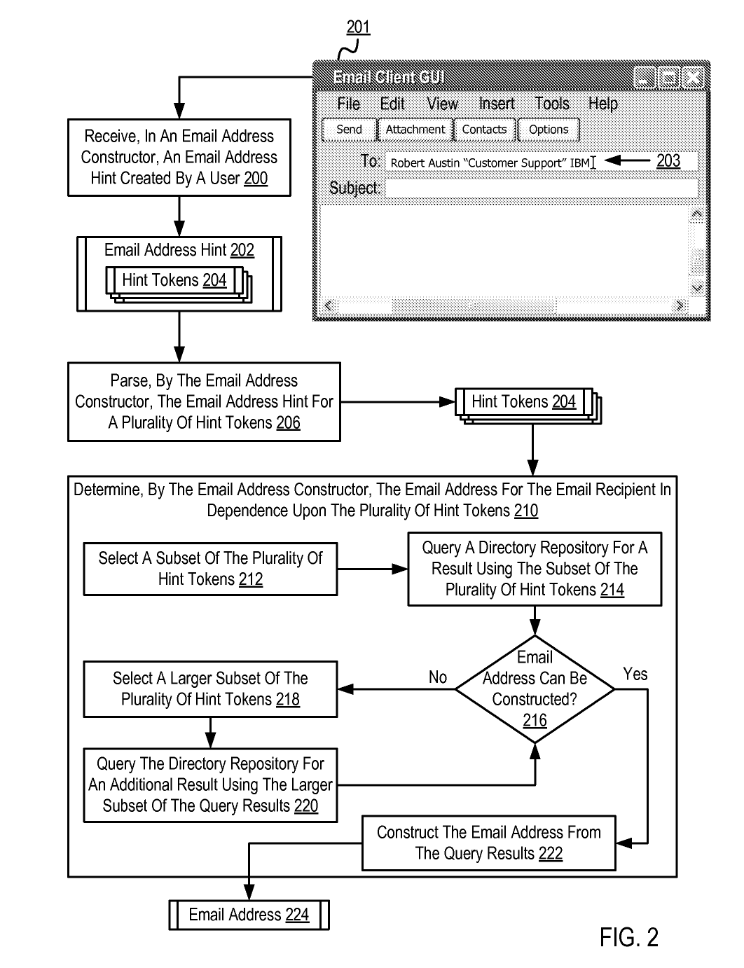

For further explanation, FIG. 2 sets forth a flow chart illustrating an exemplary method of hint-based email address construction according to embodiments of the present invention. The method of FIG. 2 includes receiving (200), in an email address constructor, an email address hint (202) specified by a user. The email address hint (202) represents an email address for an email recipient. The email address constructor may receive (200) the email address hint (202) according to the method of FIG. 2 from an email client, which in turn receives the email address hint (202) through a graphical user interface (‘GUI’) (201). The text (203) of FIG. 2 in GUI (201) illustrates an exemplary email address hint:
Robert Austin “Customer Support” IBM

The email address constructor may receive (200) the email address hint (202) according to the method of FIG. 2 as a string parameter provided to the email address constructor through a function invoked by the email client when the user tabs out of the “To:” field on the GUI (201). Readers will note that exemplary email address hint illustrated in FIG. 2 and described above is for explanation only and not for limitation.

In the example of FIG. 2, the email address hint (202) includes a plurality of hint tokens (204). Each of the hint tokens (204) specifies a user attribute for the email recipient, and at least one of the hint tokens (204) specifies an attribute other than the email recipient's name. Consider again the exemplary email address hint illustrated by text (203) in GUI (201). The exemplary email address hint includes four hint tokens, three of which specify an attribute other than the email recipient's name. The first hint token specifies that the recipient's name includes ‘Robert.’ The second hint token specifies that the recipient is located in ‘Austin.’ The third hint token specifies that the recipient belongs to the organizational department identified as ‘Customer Support.’ The fourth hint token specifies that the recipient works for ‘IBM.’ Readers will note that the exemplary email address hint above is for explanation only and not for limitation. Other email address hints having other formats and other structures may also be useful in hint-based email address construction according to embodiments of the present invention.

The method of FIG. 2 includes parsing (206), by the email address constructor, the email address hint (202) for a plurality of hint tokens (204). The email address constructor may parse (206) the email address hint (202) for a plurality of hint tokens (204) according to the method of FIG. 2 by identifying each individual hint token (204) and determining the type of attribute specified by each of the hint tokens (204). The manner in which the email address constructor identifies each individual hint token (204) may vary from one embodiment to another. Using the exemplary email address hint token illustrated by text (203) of FIG. 2, the email address constructor may identify each individual hint token (204) by dividing up the email address hint into hint tokens based on spaces not contained in quotation marks. In the exemplary email address hint token illustrated by text (203) of FIG. 2, the email address constructor may use the three spaces not contained quotation marks to identify four hint tokens. Readers will note, however, that other ways of identifying each individual hint token (204) within the email address hint (202) as will occur to those of skill in the art may be used in embodiments according to the present invention. For example, hint tokens may be separated by commas, placed in parenthesis, designated with a token identifier, and so on.

The email address construction may determine the type of attribute specified by each of the hint tokens (204) by looking up each hint token (204) in an attribute type identification table that associates common attribute types with particular words or phrases and selecting, from the attribute type identification table, the attribute type associated with each hint token (204). For example, consider the following exemplary attribute type identification table:

TABLE 1
ATTRIBUTE TYPE IDENTIFICATION TABLE

| | PRIMARY | SECONDARY |
|---|---|---|
| TOKEN | ATTRIBUTE TYPE | ATTRIBUTE TYPE |
| . . . | . . . | . . . |
| Austin | Location | Given Name |
| . . . | . . . | . . . |
| Customer Support | Organizational | NULL |
| | Department | |
| . . . | . . . | . . . |
| IBM | Company | NULL |
| . . . | . . . | . . . |
| Robert | Given Name | Surname |
| . . . | . . . | . . . |

Each entry in the exemplary attribute type identification table, associates a hint token with a primary attribute type and a secondary attribute type. The primary attribute type is the attribute type most likely to provide the semantics to the hint token that the user intended. The second primary attribute type is the attribute type second most likely to provide the semantics to the hint token that the user intended. The primary and secondary attribute type may be assigned to each possible token value based on usage statistics for various words and phrases contained in a particular language.

The exemplary attribute type identification table above illustrates four entries, each of which associates common attribute types with particular words or phrases used by a user as a hint token. The first entry associates the hint token ‘Austin’ with a primary attribute type ‘Location’ and a secondary attribute type ‘Given Name.’ That is, the first entry specifies that when the user typed the word ‘Austin,’ the user most likely intended ‘Austin’ to refer to a location and second most likely intended ‘Austin’ to refer to a person's name. The second entry associates the hint token ‘Customer Support’ with a primary attribute type ‘Organizational Department,’ but not a secondary attribute type. That is, the second entry specifies that when the user typed the phrase ‘Customer Support,’ the user most likely intended ‘Customer Support’ to refer to a department in an organization. The third entry associates the hint token ‘IBM’ with a primary attribute type ‘Company,’ but not a secondary attribute type. That is, the third entry specifies that when the user typed the word ‘IBM,’ the user most likely intended ‘IBM’ to refer to a company. The fourth entry associates the hint token ‘Robert’ with a primary attribute type ‘Given Name’ and a secondary attribute type ‘Surname.’ That is, the fourth entry specifies that when the user typed the word ‘Robert,’ the user most likely intended ‘Robert’ to refer to a recipient's first name and second most likely intended ‘Robert’ to refer to a recipient's last name. Readers will note that the exemplary attribute type identification table and the description for determining the type of attribute specified by each of the hint tokens are for explanation only and not for limitation. In fact, other ways of determining the type of attribute specified by each of the hint tokens as will occur to those of skill in the art may be used in embodiments according to the present invention.

In the method of FIG. 2, parsing (206), by the email address constructor, the email address hint (202) for a plurality of hint tokens (204) may also be carried out by storing the storing the hint tokens (204) along with their corresponding attribute type in a data structure such as, for example, a text file, and markup language document C++ object, Java object, and so on. For example, consider the following exemplary XML markup document that stores the exemplary hint tokens above along with their corresponding exemplary attribute types from above:

```
<email_address_hint>
    <token value = “Robert” type = “Given Name”/>
    <token value = “Austin” type = “Location”/>
    <token value = “Customer Support” type = “Organizational
        Department”/>
    <token value = “IBM” type = “Company”/>
</email_address_hint>
```

The method of FIG. 2 also includes determining (210), by the email address constructor, the email address (224) for the email recipient in dependence upon the plurality of hint tokens (204). The email address constructor determines (210) the email address (224) for the email recipient according to the method of FIG. 2 by selecting (212) a subset of the plurality of hint tokens (204), querying (214) a directory repository for a result using the subset of the plurality of hint tokens (204), determining (216) whether the email address (224) can be constructed from the query results, and constructing (222) the email address (224) from the query results if the email address (224) can be constructed from the query results. If the email address (224) cannot be constructed from the query results, the email address constructor determines (210) the email address (224) for the email recipient according to the method of FIG. 2 by selecting (218) a larger subset of the plurality of hint tokens (204) and querying (220) the directory repository for an additional result using the larger subset of the query results.

The email address constructor may select (212) a subset of the plurality of hint tokens (204) according to the method of FIG. 2 by selecting the first hint token included in the email address hint. Consider again the hint tokens of the exemplary email address hint illustrated by text (203) in GUI (201) of FIG. 2. The email address constructor may select (212) a subset of the plurality of hint tokens (204) by selecting the first hint token ‘Robert.’ Readers will note that selecting the first hint token is merely for explanation only and not for limitation. Other subsets of the plurality of hint tokens may be selected in other embodiments of the present invention.

The email address constructor may query (214) a directory repository for a result using the subset of the plurality of hint tokens (204) according to the method of FIG. 2 using an LDAP URL for the directory repository. For example consider the following exemplary LDAP URL used to query a directory repository using the first exemplary hint token above:
ldap://directory.net/??email?(cn=Robert)

The exemplary query above requests the return of the email field in all the entries of the directory repository where the common name field ‘cn’ has a value of ‘Robert.’ The following exemplary list of results may be returned:

LIST 1: Exemplary Query Results

. . .
robert.thompson@companyA.com
drob@companyB.com
roberth221@organizationA.org
robert@us.ibm.com
tdrobert@dod.gov
robert@organizationB.net
. . .

The email address constructor may determine (216) whether the email address (224) can be constructed from the query results by identifying the number of results returned from the query. In some embodiments, if the number of results returned from the query is one, then the email address (224) can be constructed from the query results. The email address (224) cannot be constructed from the query results if the number of results returned from the query is more than one. Using the exemplary query results returned above in such an embodiment, the email address constructor determines that email address (224) cannot be constructed from the query results above.

Readers will note that determining that the email address (224) cannot be constructed from the query results if the number of results returned from the query is more than one is for explanation and not for limitation. In other embodiments, the email address constructor may determine (216) whether the email address (224) can be constructed from the query results by identifying whether a single result can be identified from a set of query results based on other hint tokens or other information available to the email address constructor. For example, using the exemplary query results above and the additional hint token ‘IBM,’ the email address constructor may identify a single result ‘robert@us.ibm.com,’ thereby determining that the email address (224) can be constructed from the query results. For still further explanation, consider the following exemplary query:
ldap://directory.net/??username, company?(cn=Robert)

The exemplary query above requests the return of the email username field and the company field in all the entries of the directory repository where the common name field ‘cn’ has a value of ‘Robert.’ Further consider that the exemplary query above returns the following exemplary query results:

LIST 2: Exemplary Query Results

| | |
|---|---|
| . . . | . . . |
| robert.thompson | companyA |
| drob | companyB |
| roberth221 | organizationA |
| robert | IBM |
| tdrobert | DOD |
| Robert | organizationB |
| . . . | . . . |

Using the exemplary query results above, the email address constructor may identify a single result ‘robert’ from the exemplary query results above using the additional hint token ‘IBM’ already provided to the email address constructor. In such an embodiment, therefore, the email address constructor may determine that the email address (224) can be constructed from the query results.

The email address constructor may construct (222) the email address (224) from the query results according to the method of FIG. 2 by concatenating a portion of the query results with other information available to the email address constructor. For example, consider the exemplary query results returned in List 2 above. Because the email address constructor has already identified that the email recipient is employed at IBM from the hint tokens, the email address constructor may concatenate the username ‘robert’ from the query results for the user who works at ‘IBM’ and has a common name of ‘Robert’ with the email domain name ‘ibm.com’ for IBM that the email address constructor may have obtained in some other query.

In other embodiments, the email address constructor may construct (222) the email address (224) from the query results according to the method of FIG. 2 by selecting the email address returned from the query results. Such an embodiment may be useful when the query results return email address and only one result is returned from the query.

When the email address (224) cannot be constructed from the query results, the email address constructor may select (218) a larger subset of the plurality of hint tokens (204) and querying (220) the directory repository for an additional result using the larger subset of the query results. The email address constructor may select (218) a larger subset of the plurality of hint tokens (204) according to the method of FIG. 2 by adding one or more additional hint tokens to the query for the directory repository and may query (220) the directory repository for an additional query result using the additional hint tokens. For example, consider the following exemplary query that is similar to the exemplary query above, except that additional hint token are included in the query:

ldap://directory.net/??email?(&(cn=Robert)(location=Austin)
(department=Customer Support))

The exemplary query above requests the return of the email field in all the entries of the directory repository where the common name field ‘cn’ has a value of ‘Robert,’ the field ‘location’ has a value of ‘Austin,’ and the field ‘department’ has a value of ‘Customer Support.’ The following exemplary list of results may be returned:

LIST 3: Exemplary Query Results
robert@us.ibm.com

Upon receiving the exemplary query results above, the email address constructor may determine (216) that the email address (224) can be constructed from the query results because only a single result containing an email address is returned. The email address constructor may then construct (222) the email address from the query results by selecting the email address (224) in the single query result. The email address constructor may then return the email address (224) for further processing to the email client as a return parameter for the function invoked by the email client to request the hint-based email address construction according to embodiments of the present invention.

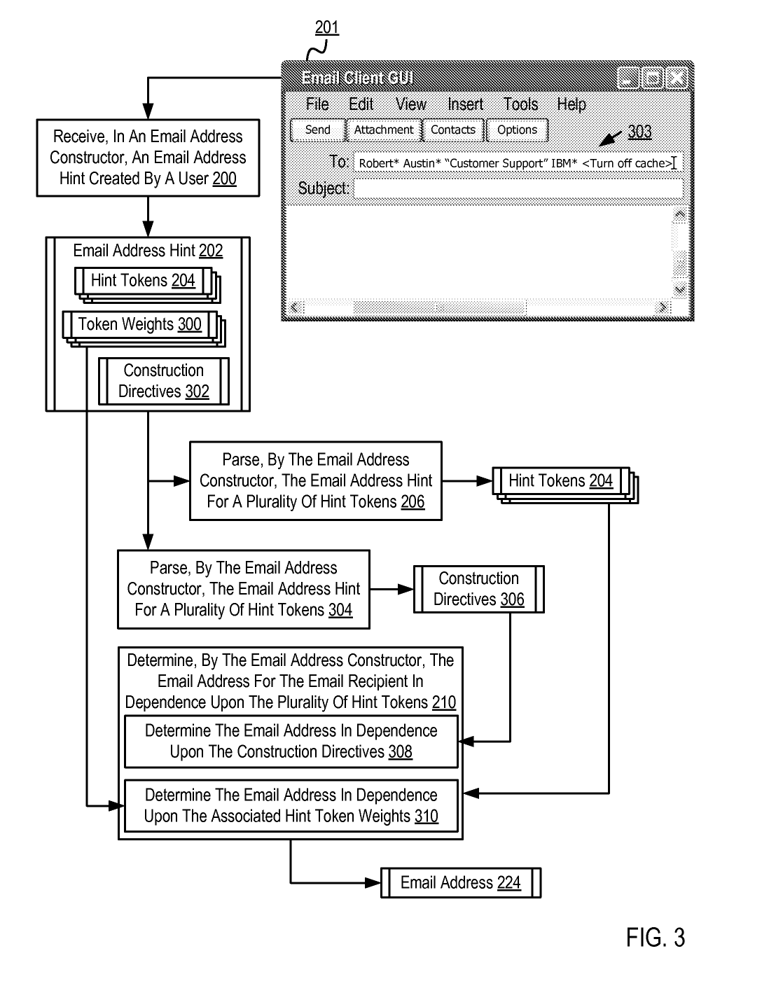

Readers will note that in some embodiments the hint tokens included in the email address hint may each be associated with a hint token weight that is used to indicate the relative significance that a particular hint token relative to the other hint tokens. For example, a user may want to indicate that the user is confident that certain attributes describe a particular email recipient, while indicating that the user is not as confident concerning how well other attributes describe a particular user. For example, a user may be confident that the email recipient is located in Austin and is employed with IBM, but the user is less confident that the email recipient works in the Customer Support department. For further explanation, consider FIG. 3 that sets forth a flow chart illustrating a further exemplary method of hint-based email address construction according to embodiments of the present invention in which each hint token (204) is associated with a hint token weight (300).

The method of FIG. 3 is similar to the method of FIG. 2. The method of FIG. 3 includes: receiving (200), in an email address constructor, an email address hint (202) specified by a user, the email address hint (202) representing an email address for an email recipient; parsing (206), by the email address constructor, the email address hint (202) for a plurality of hint tokens (204), each of the hint tokens (204) specifying a user attribute for the email recipient, and at least one of the hint tokens (204) specifying an attribute other than the email recipient's name; and determining (210), by the email address constructor, the email address (224) for the email recipient in dependence upon the plurality of hint tokens (204).

As mentioned above, each hint token (204) is associated with a hint token weight (300). Consider the exemplary email address hint illustrated by the text (303) in GUI (201):
Robert*Austin*“Customer Support”IBM*<Turn off cache>

The exemplary email address hint above specified by the user through GUI (201) includes four hint tokens—‘Robert,’ ‘Austin,’ ‘Customer Support,’ and ‘IBM.’ Each of the exemplary hint tokens are associated with a hint token weight by the presence or absence of a ‘*’ after each token. A ‘*’ after a hint token in the example of FIG. 3 indicates that the user is confident that the corresponding hint token accurately describes the email recipient. The absence of a ‘*’ after a hint token in the example of FIG. 3 indicates that the user is less than confident that the corresponding hint token accurately describes the email recipient. In the example of FIG. 3, because the hint tokens ‘Robert,’ ‘Austin,’ and ‘IBM,’ are each followed by a ‘*,’ the email address constructor identifies that that the user is confident that the email recipient's name is ‘Robert’ and that the recipient is employed with ‘IBM’ at the ‘Austin’ location. Readers will note that the manner of specifying the weights for each of the hint tokens in the example of FIG. 3 is for explanation and not for limitation. Other ways of specifying weights associated with each of the hint tokens as will occur to those of ordinary skill in the art are well within the scope of embodiments of the present invention.

The method of FIG. 3 includes parsing (304), by the email address constructor, the email address hint (202) for one or more construction directives (302). Each construction directive (302) of FIG. 3 specifies parameters for constructing the email address (224) using the plurality of hint tokens (204). Examples of construction directives may include hint token weight, cache directives, search directives, and so on. The exemplary email address hint token illustrated by text (303) of FIG. 3 includes the exemplary construction directive:
<Turn off cache>

The exemplary construction directive above is a cache directive that instructs the email address constructor to bypass any data stored in a local cache when determining (210) email address for the email recipient.

In the method of FIG. 3, determining (210), by the email address constructor, the email address (224) for the email recipient in dependence upon the plurality of hint tokens (204) includes determining (308) the email address (224) in dependence upon the construction directives (306). The manner in which the email address constructor determines (308) the email address (224) in dependence upon the construction directives (306) according to the method of FIG. 3 may vary from one embodiment to another depending on the particular construction directive used. Consider the exemplary construction directive ‘<Turn off cache>.’ The email address constructor may determine (308) the email address (224) in dependence upon the construction directives (306) according to the method of FIG. 3 may be carried out by querying a directory repository using the hint tokens without retrieving any cached results from pervious queries that were similar.

In the method of FIG. 3, determining (210), by the email address constructor, the email address (224) for the email recipient in dependence upon the plurality of hint tokens (204) includes determining (310) the email address in dependence upon the associated hint token weights (300). The email address constructor may determine (310) the email address in dependence upon the associated hint token weights (300) according to the method of FIG. 3 by selecting one or more the hint tokens having the highest token weight, querying a directory repository for a result using the selected hint tokens, determining whether the email address (224) can be constructed from the query results, and constructing the email address (224) using the query result if the email address can be constructed from the query results. If the email address cannot be constructed from the query results, the email address constructor selects a larger subset that may include hint tokens having lower token weights and queries the directory repository for an additional result using the larger subset. In such a manner, the email address constructor performs a query of the directory repository using the tokens with the highest token weight. Only if the results are not adequate does the email address constructor in the method of FIG. 3 query the directory repository using hint tokens having lower token weights. Readers will note that hint tokens having higher token weights indicate that the user is more confident that the token accurately describes the email recipient, and hint tokens having lower token weights indicate that the user is less confident that the token accurately describes the email recipient.

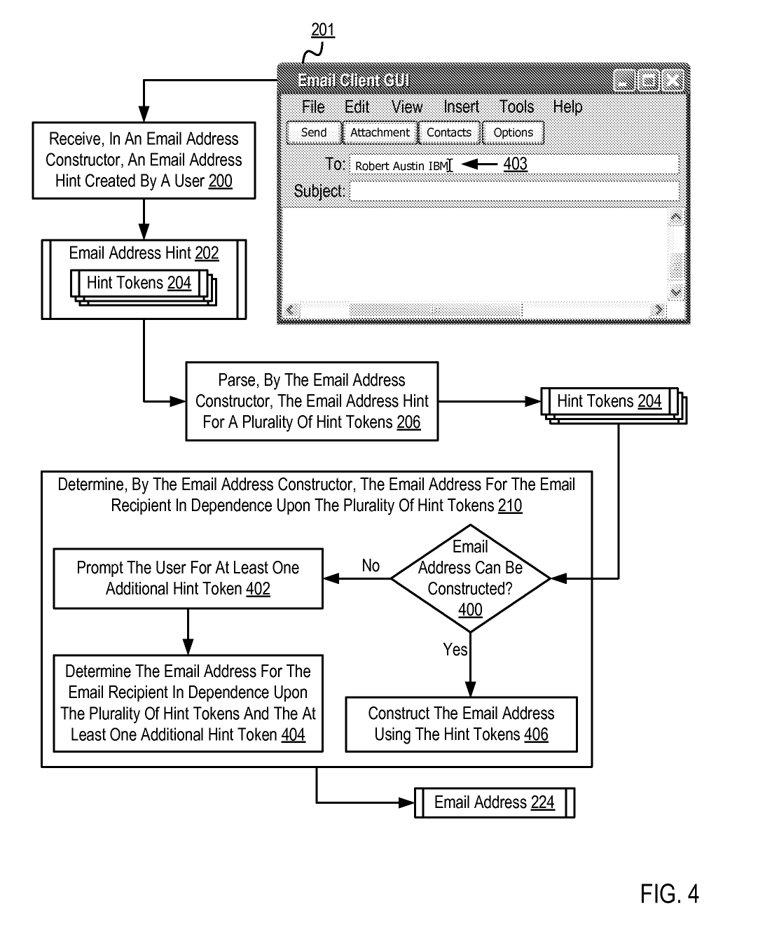

In some embodiments, the email address constructor may not be able to determine an email address for the email recipient based exclusively on the hint tokens included email address hint because the email address constructor needs additional hint tokens to construct the email recipient's email address. For further explanation, therefore, consider FIG. 4 that sets forth a flow chart illustrating a further exemplary method of hint-based email address construction according to embodiments of the present invention.

The method of FIG. 4 is similar to the method of FIG. 2. The method of FIG. 4 includes: receiving (200), in an email address constructor, an email address hint (202) specified by a user, the email address hint (202) representing an email address for an email recipient; parsing (206), by the email address constructor, the email address hint (202) for a plurality of hint tokens (204), each of the hint tokens (204) specifying a user attribute for the email recipient, and at least one of the hint tokens (204) specifying an attribute other than the email recipient's name; and determining (210), by the email address constructor, the email address (224) for the email recipient in dependence upon the plurality of hint tokens (204).

The method of FIG. 4 differs from the method of FIG. 2 in that determining (210), by the email address constructor, the email address (224) for the email recipient in dependence upon the plurality of hint tokens (204) includes determining (400) whether the email address (224) can be constructed from the plurality of hint tokens (204), prompting (402) the user for at least one additional hint token (204) if the email address (224) cannot be constructed from the plurality of hint tokens (204), and determining (404) the email address (224) for the email recipient in dependence upon the plurality of hint tokens (204) and the at least one additional hint token. If the email address (224) can be constructed from the plurality of hint tokens (204), the email address constructor may determine (210) the email address (224) for the email recipient by constructing the email address using the hint tokens (406) as described above.

In some embodiments, the email address constructor may determine (400) whether the email address (224) can be constructed from the plurality of hint tokens (204) according to the method of FIG. 4 by identifying the number of results returned from a query using the hint tokens (204). If the number of results returned from the query is one, then the email address (224) can be constructed from the plurality of hint tokens (204). The email address (224) cannot be constructed from the plurality of hint tokens (204) if the number of results returned from the query is more than one. In some other embodiments, the email address constructor may determine (400) whether the email address (224) can be constructed from the plurality of hint tokens (204) according to the method of FIG. 4 by identifying whether a the email address can be derived from a set of query results based on the hint tokens (204) and other information already available to the email address constructor. If the email address can be derived from a set of query results based on the hint tokens (204) and other information already available to the email address constructor, then the email address (224) can be constructed from the plurality of hint tokens (204). The email address (224) cannot be constructed from the plurality of hint tokens (204), however, if the email address can be derived from a set of query results based on the hint tokens (204) and other information already available to the email address constructor.

If the email address (224) cannot be constructed from the plurality of hint tokens (204), the email address constructor may prompt (402) the user for at least one additional hint token according the method of FIG. 4 by notifying the user that additional hint tokens are needed through a GUI rendered on a computer display and receiving the additional hint tokens from the user through an input device such as, for example, a keyboard or a microphone. The email address constructor may then determine (404) the email address (224) for the email recipient in dependence upon the plurality of hint tokens (204) and the at least one additional hint token received from the user. Consider, for example, the exemplary email address hint illustrated by text (403) in GUI (201) of FIG. 4:
Robert Austin IBM

If the email address (224) cannot be constructed from the hint tokens ‘Robert,’ ‘Austin,’ and ‘IBM,’ then the email address constructor may prompt (402) the user for at least one additional hint token. The user may provide the email address constructor with an additional hint token of ‘Customer Support.’ Using the hint tokens ‘Robert,’ ‘Austin,’ and ‘IBM,’ and the additional hint token of ‘Customer Support,’ the email address constructor may then determine (404) the email address (224) for the email recipient.

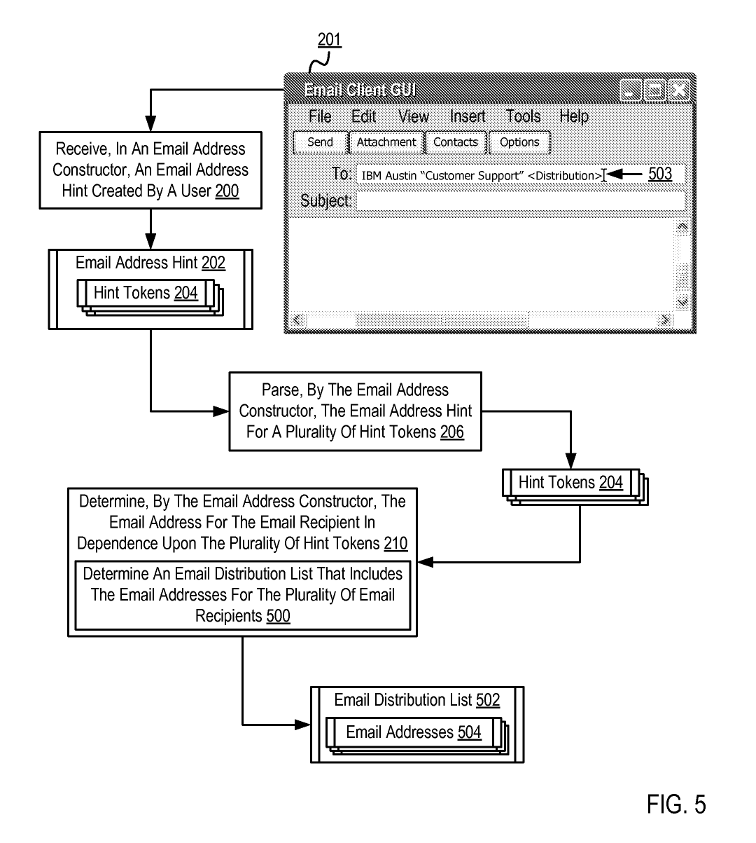

In the description above with reference to FIGS. 2-4, the email address constructor determines a single email address for single email recipient in dependence upon the plurality of hint tokens. Readers will note, however, that in other embodiments, the email address constructor may determine an email distribution list that includes the email addresses for the plurality of email recipients. For further explanation, therefore, consider FIG. 5 that sets forth a flow chart illustrating a further exemplary method of hint-based email address construction according to embodiments of the present invention.

The method of FIG. 5 is similar to the method of FIG. 2. The method of FIG. 5 includes: receiving (200), in an email address constructor, an email address hint (202) specified by a user, the email address hint (202) representing an email address for an email recipient; parsing (206), by the email address constructor, the email address hint (202) for a plurality of hint tokens (204), each of the hint tokens (204) specifying a user attribute for the email recipient, and at least one of the hint tokens (204) specifying an attribute other than the email recipient's name; and determining (210), by the email address constructor, the email address (224) for the email recipient in dependence upon the plurality of hint tokens (204).

In the example of FIG. 5, the email address hint (202) represents email addresses for a plurality of email recipients using hint tokens (204). Each of the hint tokens (204) specifies a user attribute for the plurality of email recipients. At least one of the hint tokens (204) specifies an attribute other than the email recipients' name.

In the method of FIG. 5, determining (210), by the email address constructor, the email address for the email recipient in dependence upon the plurality of hint tokens (204) includes determining (500) an email distribution list (502) that includes the email addresses (504) for the plurality of email recipients. The email distribution list (502) of FIG. 5 may specify the email address (504) for email recipients in a text file, in a markup language document, in a C++ or Java object, or in any other manner as will occur to those of skill in the art. This email distribution list (502) may itself be associated with an email address. When an email is sent to the email address, the email is automatically redistributed to each of the email addresses in the email distribution list. The email address constructor may determine (500) the email distribution list (502) according to the method of FIG. 5 by querying a directory repository for results using the hint tokens (204), constructing emails addresses (504) using the query results, and storing the email addresses (504) together in the email distribution list (502).

Exemplary embodiments of the present invention are described largely in the context of a fully functional computer system for hint-based email address construction. Readers of skill in the art will recognize, however, that the present invention also may be embodied in a computer program product disposed on a computer readable media for use with any suitable data processing system. Such computer readable media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of hint-based email address construction, the method comprising:
receiving, in an email address constructor, an email address hint specified by a user, the email address hint representing an email address for an email recipient;
parsing, by the email address constructor, the email address hint for a plurality of hint tokens, each of the hint tokens specifying a user attribute for the email recipient, and at least one of the hint tokens specifying an attribute other than the email recipient's name; and
determining, by the email address constructor, the email address for the email recipient in dependence upon the plurality of hint tokens.

2. The method of claim 1 wherein determining, by the email address constructor, an email address for the email recipient in dependence upon the plurality of hint tokens further comprises:
selecting a subset of the plurality of hint tokens;
querying a directory repository for a result using the subset of the plurality of hint tokens;
determining whether the email address can be constructed from the query result; and
if the email address cannot be constructed from the query results:
selecting a larger subset of the plurality of hint tokens, and
querying the directory repository for an additional result using the larger subset of the plurality of hint tokens.

3. The method of claim 1 wherein:
each hint token is associated with a hint token weight; and
determining, by the email address constructor, an email address for the email recipient in dependence upon the plurality of hint tokens further comprises determining the email address in dependence upon the associated hint token weights.

4. The method of claim 1 wherein:
the method further comprises parsing, by the email address constructor, the email address hint for one or more construction directives, each construction directive specifying parameters for constructing the email address using the plurality of hint tokens; and
determining, by the email address constructor, an email address for the email recipient in dependence upon the plurality of hint tokens further comprises determining the email address in dependence upon the construction directives.

5. The method of claim 1 wherein determining, by the email address constructor, the email address for the email recipient in dependence upon the plurality of hint tokens further comprises:
determining whether the email address can be constructed from the plurality of hint tokens;
prompting the user for at least one additional hint token if the email address cannot be constructed from the plurality of hint tokens; and
determining the email address for the email recipient in dependence upon the plurality of hint tokens and the at least one additional hint token.

6. The method of claim 1 wherein:
the email address hint represents email addresses for a plurality of email recipients;
each of the hint tokens specifying a user attribute for the plurality of email recipients, and at least one of the hint tokens specifying an attribute other than the email recipients’ name; and
determining, by the email address constructor, the email address for the email recipient in dependence upon the plurality of hint tokens further comprises determining an email distribution list that includes the email addresses for the plurality of email recipients.

7. The method of claim 1 wherein the email address constructor executes on an email server.

8. Apparatus for hint-based email address construction, the apparatus comprising a computer processor, a computer memory operatively coupled to the computer processor, the computer memory having disposed within it computer program instructions capable of:
receiving, in an email address constructor, an email address hint specified by a user, the email address hint representing an email address for an email recipient;
parsing, by the email address constructor, the email address hint for a plurality of hint tokens, each of the hint tokens specifying a user attribute for the email recipient, and at least one of the hint tokens specifying an attribute other than the email recipient's name; and
determining, by the email address constructor, the email address for the email recipient in dependence upon the plurality of hint tokens.

9. The apparatus of claim 8 wherein determining, by the email address constructor, an email address for the email recipient in dependence upon the plurality of hint tokens further comprises:
selecting a subset of the plurality of hint tokens;
querying a directory repository for a result using the subset of the plurality of hint tokens;
determining whether the email address can be constructed from the query result; and
if the email address cannot be constructed from the query results:
selecting a larger subset of the plurality of hint tokens, and
querying the directory repository for an additional result using the larger subset of the plurality of hint tokens.

10. The apparatus of claim 8 wherein:
each hint token is associated with a hint token weight; and
determining, by the email address constructor, an email address for the email recipient in dependence upon the plurality of hint tokens further comprises determining the email address in dependence upon the associated hint token weights.

11. The apparatus of claim 8 wherein:
the computer memory has disposed within it computer program instructions capable of parsing, by the email address constructor, the email address hint for one or more construction directives, each construction directive specifying parameters for constructing the email address using the plurality of hint tokens; and
determining, by the email address constructor, an email address for the email recipient in dependence upon the plurality of hint tokens further comprises determining the email address in dependence upon the construction directives.

12. The apparatus of claim 8 wherein determining, by the email address constructor, the email address for the email recipient in dependence upon the plurality of hint tokens further comprises:
determining whether the email address can be constructed from the plurality of hint tokens;
prompting the user for at least one additional hint token if the email address cannot be constructed from the plurality of hint tokens; and
determining the email address for the email recipient in dependence upon the plurality of hint tokens and the at least one additional hint token.

13. A computer program product for hint-based email address construction, the computer program product disposed in a computer readable medium, the computer program product comprising computer program instructions capable of:
receiving, in an email address constructor, an email address hint specified by a user, the email address hint representing an email address for an email recipient;
parsing, by the email address constructor, the email address hint for a plurality of hint tokens, each of the hint tokens specifying a user attribute for the email recipient, and at least one of the hint tokens specifying an attribute other than the email recipient's name; and
determining, by the email address constructor, the email address for the email recipient in dependence upon the plurality of hint tokens.

14. The computer program product of claim 13 wherein determining, by the email address constructor, an email address for the email recipient in dependence upon the plurality of hint tokens further comprises:
selecting a subset of the plurality of hint tokens;
querying a directory repository for a result using the subset of the plurality of hint tokens;
determining whether the email address can be constructed from the query result; and
if the email address cannot be constructed from the query results:
selecting a larger subset of the plurality of hint tokens, and
querying the directory repository for an additional result using the larger subset of the plurality of hint tokens.

15. The computer program product of claim 13 wherein:
each hint token is associated with a hint token weight; and
determining, by the email address constructor, an email address for the email recipient in dependence upon the plurality of hint tokens further comprises determining the email address in dependence upon the associated hint token weights.

16. The computer program product of claim 13 wherein:
the computer program product further comprises computer program instructions capable of parsing, by the email address constructor, the email address hint for one or more construction directives, each construction directive specifying parameters for constructing the email address using the plurality of hint tokens; and
determining, by the email address constructor, an email address for the email recipient in dependence upon the plurality of hint tokens further comprises determining the email address in dependence upon the construction directives.

17. The computer program product of claim 13 wherein determining, by the email address constructor, the email address for the email recipient in dependence upon the plurality of hint tokens further comprises:
determining whether the email address can be constructed from the plurality of hint tokens;
prompting the user for at least one additional hint token if the email address cannot be constructed from the plurality of hint tokens; and
determining the email address for the email recipient in dependence upon the plurality of hint tokens and the at least one additional hint token.

18. The computer program product of claim 13 wherein:
the email address hint represents email addresses for a plurality of email recipients;
each of the hint tokens specifying a user attribute for the plurality of email recipients, and at least one of the hint tokens specifying an attribute other than the email recipients’ name; and
determining, by the email address constructor, the email address for the email recipient in dependence upon the plurality of hint tokens further comprises determining an email distribution list that includes the email addresses for the plurality of email recipients.

19. The computer program product of claim 13 wherein the computer readable medium comprises a recordable medium.

20. The computer program product of claim 13 wherein the computer readable medium comprises a transmission medium.
